(19) United States
(12) Patent Application Publication
(10) Pub. No.: US 2023/0315871 A1
(43) Pub. Date: Oct. 5, 2023

(54) Methods and systems for vetted secure access of a remote desktop utilizing contextual application information

(71) Applicants: Sichao Liu, Irvine, CA (US); Zhihao Yao, Irvine, CA (US)

(72) Inventors: Sichao Liu, Irvine, CA (US); Zhihao Yao, Irvine, CA (US)

(21) Appl. No.: 17/803,246

(22) Filed: Mar. 31, 2022

(51) Int. Cl. G06F 21/60; G06F 21/62

(52) U.S. Cl. CPC G06F 21/604; G06F 21/629

(57) ABSTRACT

Methods and systems are disclosed for facilitating secure remote desktop session comprising: utilizing contextual application information to determine the rules for vetting GUI components; facilitating the construction of rules based on the confidentiality of each graphics component in an application that is to be displayed remotely on a client; facilitating the construction of rules based on the permissible range of remote control of each GUI component that acceptable user inputs in an application that is to be displayed and controlled remotely by one or more clients; enforcing the rules through selectively forwarding GUI components, automatically modifying the GUI components based on the rules, and validating the inputs from one or more clients.

### CROSS-REFERENCE TO RELATED APPLICATION

This application claims priority to U.S. Provisional Patent Application No. 63/170,481 titled “Methods and systems for vetted secure access of a remote desktop utilizing contextual application information” and filed on Apr. 3, 2021.

### BACKGROUND OF THE INVENTION

### 1. Field of the Invention

The various embodiments and aspects described herein relate to a system for providing secure remote access to computer Graphical User Interface (GUI).

### 2. Description of the Prior Art

In recent years, remote desktops have become ubiquitous. Some reasons for using a remote desktop include, but are not limited to, remote work, remote collaboration, remote access to applications and systems that are not available locally, access to cloud computing environments, etc. Remote desktop allows for accessing a computing system's display and other input and output devices from another computing system over the network. Typically, a remote desktop utilizes one or more clients that is coupled with a remote server. The remote server typically refers to the computing device being remotely controlled over a network, and it does not have to be physically far from the clients. The clients control a remote server during a remote desktop session over the network. A remote desktop software typically relays the GUI contents from a remote server to the clients, and the clients typically transmits mouse, keyboard and possibly other inputs to the remote server, allowing the user who is physically present at a client to interact with the remote server.

The remote desktop session may provide a very similar experience to accessing applications, systems, and data on the remote server as if the user was physically present at the server. When a remote desktop session is initiated, it typically starts with a user authenticating to the remote server to gain access. The authentication may be performed by the methods include, but are not limited to, passwords, one-time pad, challenge-response mechanisms, and physical authentication devices, etc. Once authenticated, the user may start a remote desktop session. The remote desktop session typically transmits GUI contents from the remote server to the clients and transmits inputs from the clients to the remote server, allowing the user to execute applications, access data and manipulate the applications and data.

Remote desktop sessions are sensitive to various attacks. One common attack is session eavesdropping. A remote desktop session may be unencrypted, and the user's interaction with the remote server may be accessible to a third party who is monitoring the network traffic between the clients and the remote server. To address this security concern, a remote desktop session may be encrypted using a Virtual Private Network (VPN), Secure Socket Layer (SSL), or other encryption techniques. However, even if the communications between the clients and the remote server are encrypted, the contents are typically decrypted once received by the clients, and thus are subject to leakage if any client computer system is compromised.

Another common attack is unauthorized access to remote servers. A remote server may be accessed unauthorized if an attacker obtains the credentials necessary to access the remote server. Using easy-to-guess passwords increases the chance of unauthorized access.

Alternatively, if the credential to access a remote server is stored within a client computer system, an attacker may compromise the client and use the compromised system to access the remote server and gain access to the sensitive data, applications, and systems. To address this security concern, a remote desktop session may be protected with one-time passwords, challenge-response mechanisms, physical authentication devices, etc. In addition to credential-based authentication, a system administrator may also explicitly allow or disallow a remote desktop session based on a client's identification information, such as location, the Media Access Control address (MAC address), the Internet Protocol address (IP address), etc.

In addition to the aforementioned user cases and scenarios, the following challenges also present, which a secure remote desktop solution must address:
1) It may be possible to safeguard the credentials through good security practices, but the clients, which are often personal computers, may not have a high level of security assurance and thus be subject to cyber-attacks and unauthorized physical access. A compromised client may be utilized by an attacker to gain unauthorized access to a remote server.
2) It may be difficult to determine whether a client is accessing the remote server for authorized or unauthorized purposes. Monitoring may not be possible in all use cases due to the cost, and even if monitoring is possible, it may not prevent unauthorized access in the real-time.
3) It is difficult to determine whether the user accessing the remote server is the same user who initiated the remote desktop session. Children, inadvertent family members and guests may access the remote session and cause unexpected harm to a server system. In the scenario that a remote server controls critical infrastructure, such as a power plant's control system, it may be very important to ensure the user accessing the remote server is the same user who initiated the remote desktop session, and that the user is authorized.

The prior arts may authenticate the identity of clients, but do not conduct fine-grained permission control once authenticated. Accordingly, there is a need for methods and systems that facilitate fine-grained, vetted secure access to a remote desktop where a client is authenticated but not fully trusted.

### BRIEF SUMMARY OF THE INVENTION

To address the foregoing challenges, various aspects of the systems and methods for providing secure vetted remote access to computer user interfaces are disclosed herein, for example, mitigating the security hazard of blindly trusting clients.

In one aspect of the present disclosure, the method comprises verifying the clients and providing a remote desktop session to the clients. The method, among others, comprises receiving a request to access a remote server, wherein the request is received from a client, authenticating the request from the client, wherein the authenticating comprises authenticating the client, determining whether the client is eligible to access the remote desktop session, wherein the determining is based on at least one of the client's location, the client's MAC address, the client's IP address, the client's user, the client's system configuration, the client's application, the client's history of requests, the client's past behavior, the client's environment, the client's behavioral model and the client's reputation, and sending the request to access the remote desktop session to the remote server for execution if the client is determined to be eligible to access the remote desktop session.

In accordance with this invention, the method, among others, also comprises determining an application that is being used in the remote desktop session, and determining one or more access rules for the application. The access rules are based on the contextual information of the application and the client. The access rules may be manually provided by a human operator.

In accordance with this invention, the method, among others, also comprises configuring a GUI filter based on the access rule, and filtering the remote desktop network data to prevent the client from viewing or interacting with a certain portion of the application. The method, among others, may consist of one or more of the following: facilitating the construction of GUI filters based on the confidentiality of each GUI component in an application that is to be displayed remotely on clients; facilitating the construction of the GUI filter based on the permissible range or scope of remote control of each GUI component that accepts user inputs in an application that is to be controlled remotely by clients.

In accordance with this invention, the method, among others, also comprises facilitating the enforcement of the GUI filters through selectively transmitting and/or modifying GUI components from a remote server to clients, and validating remote inputs provided by clients.

### BRIEF DESCRIPTION OF THE SEVERAL VIEWS OF THE DRAWING

The above and other features and advantages of the present invention will become more apparent from the following description and accompanying drawings, wherein:

FIG. 1 illustrates a remote access system configured in accordance with embodiments of the invention.

FIG. 2 illustrates an application GUI that is being displayed on the remote server.

FIG. 3 illustrations the application GUI being displayed on the client after the sample set of rules are enforced.

FIG. 4 demonstrates an actual reduction to practice of the systems and methods.

FIG. 5 shows a flow chart for generating GUI filter rules in accordance with embodiments of the invention.

FIG. 6 shows a flow chart for filtering outgoing GUI data sent by the remote server in accordance with embodiments of the invention.

FIG. 7 shows a flow chart for validating incoming GUI inputs received by the remote server in accordance with embodiments of the invention.

### DETAILED DESCRIPTION OF THE INVENTION

The detailed description below is intended as an illustration of demonstrative configurations and is not intended to be interpreted as the only configurations.

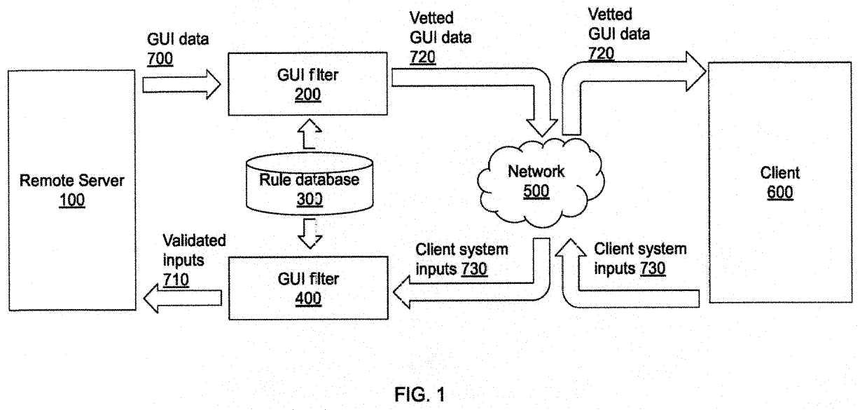

FIG. 1 illustrates a remote access system configured in accordance with embodiments of the invention. The exemplary remote desktop system comprising a remote server 100 and a client 600, wherein the remote server 100 is remotely controlled by the client 600. The period of remote control is also known as a remote desktop session. One skilled in the art will recognize that a remote desktop session may be supported by a well-known remote desktop software, or a customized remote desktop application for use in the system in accordance with embodiments of the invention.

On the left side of network 500 is the subsystem of the remote server, and on the right side of network 500 is the subsystem of the client. During a remote desktop session, a remote server 100 sends the GUI data 700 of an application to a GUI filter 200, which may filter out any disallowed GUI component, and modify GUI components in accordance with the rule(s) in the rule database 300. The application's GUI data may include buttons, window layouts, labels, input boxes, and other GUI widgets that either come with a programming language's GUI library, or customized by an experienced developer. The GUI filter 200 may be implemented on the same physical machine as the remote server 100, such that the GUI data are filtered after the remote server generates the GUI data and right before the GUI data are sent out to the network 500. The GUI filter 200 may also be implemented as a separate computer system that connects between the remote server 100 and the network 500. In such a case, the GUI data may be sent through various means of connection from the remote server 100 to the GUI filter 200, wired or wireless, or a combination of both.

Rule database 300 may store records of rules that are added according to the contextual information of an application and of the clients. Confidentiality rules and input limitation rules are two examples of rules. Confidentiality rules declare whether a GUI component should be visible by client 600. For example, a record of confidentiality rule may consist of the identifier of a GUI widget, and the rule that whether the GUI widget should not be visible by a client. Input limitation rules restrict the range of input that a client may be allowed to provide. For example, a record of input limitation rule may consist of the identifier of a GUI widget of an application, and the permissible value of inputs a client may be allowed to provide. The rule database 300 may be compiled by a human operator who is familiar with the context of the application used in the remote desktop session.

GUI filter 200 and GUI filter 400 utilize the rule database 300 to examine the GUI data. Examine means searching the rule database 300 for records of rules that match the requested criteria. The search criteria may be the identifier of a GUI component, or a certain category or group of GUI components based on type, font, color, size, location, or other identifying characteristics. GUI filter 200 may enforce both the confidentiality rules and the input limitations rules. For example, for enforcing confidentiality rules, GUI filter 200 may remove a GUI component from the outgoing data; for enforcing the input limitation rules, GUI filter 200 may modify a GUI component, so that it visually prohibits disallowed inputs, graying out a button for example. GUI filter 200, 400 may be a well-known firewall application, or may be a customized network traffic filtering application for use in the system in accordance with embodiments of the invention. Client 600 is connected to network 500. The client 600 may be a personal computer, a mobile device, or a server computer. Client 600 may be configured to receive vetted GUI data 720 from network 500. GUI filter 200 sends the vetted GUI data 720 to client 600 through network 500. One skilled in the art will recognize that network 500 may be a wired connection, a wireless connection, or a combination of the two, or any other manner of connecting computer systems. Client 600 receives the vetted GUI data 720 through network 500, and displays the vetted GUI data 720. Client 600 may utilize a well-known remote desktop application, or it may use a customized remote GUI receiving and rendering application for use in the system in accordance with embodiments of the invention.

Client 600 may also be configured to send inputs 730 to remote server 100 through network 500. A human operating may provide input using the client 600's keyboard, or pointing device (e.g., mouse), or any other computer input devices. The inputs 730 are transmitted back to the remote server 100 through network 500, subject to GUI filter 400 which utilizes rule database 300 to determine whether the GUI input 730 is allowed or disallowed. GUI filter 400 may examine the GUI input against the input limitation rules.

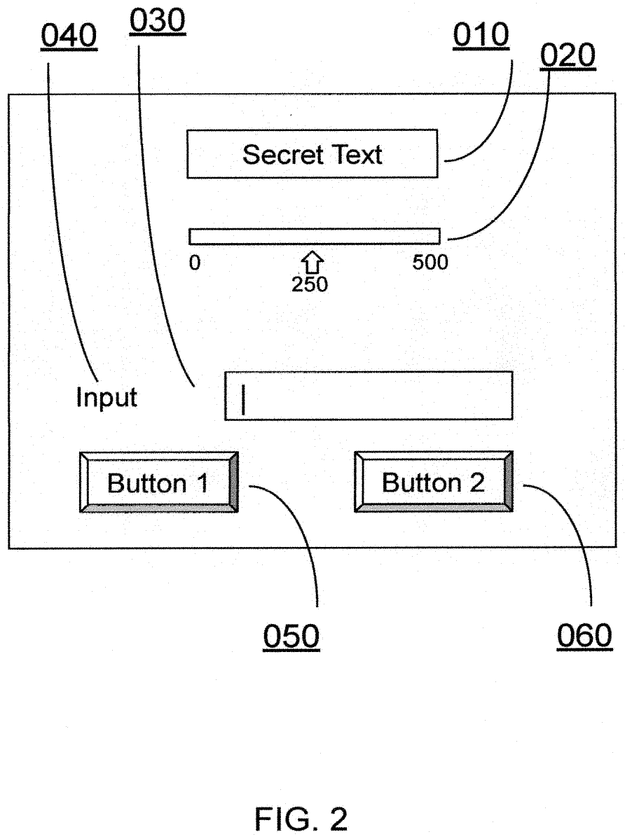

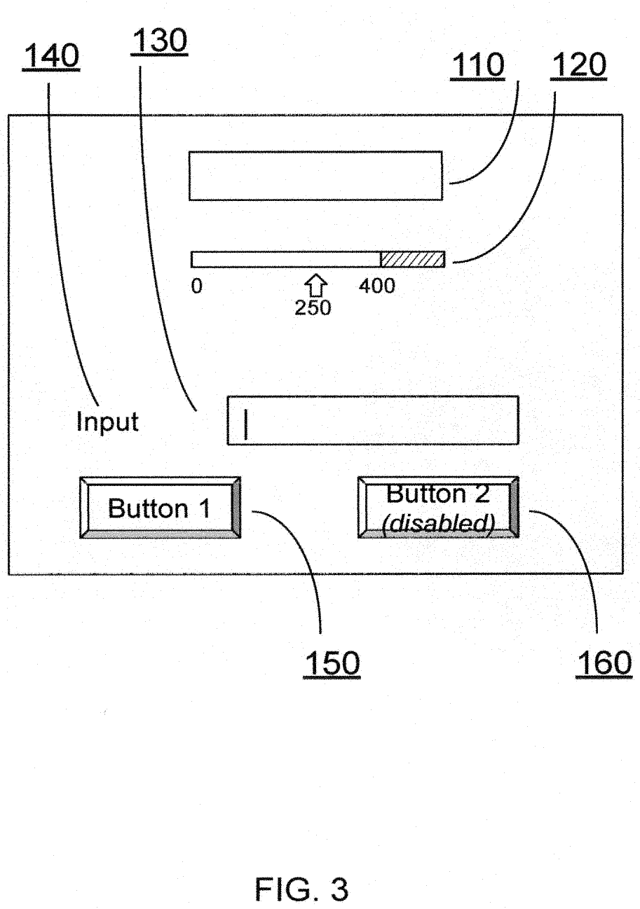

FIG. 2 shows the application GUI that is being displayed on the remote server, and FIG. 3 shows the application GUI being displayed on the client after the sample set of rules are enforced. The sample application is used for the purpose of illustrating how a sample set of rules affects the capabilities of the client, and eventually increases the safety of the application that runs on the remote server.

FIG. 2 illustrates an application GUI that is being displayed on the remote server. Within the application, a sample layout is shown, which consists of a label 010, a slider widget 020, an input text box 030, another label 040, and two buttons 050, 060. The sample set of rules in this example are, 1) the text in label 010 shall not be seen by the client; 2) the slider widget 020 shall be set larger than 400 by the client; 3) the button 060 shall not be clickable by the client; 4) all other inputs to the GUI components shall be permitted at the same privilege as the remote server. FIG. 3 illustrates the application GUI being displayed on the client after the sample set of rules are enforced. Within the application, the layout consists of a label 110 with text removed according to the confidentiality rule, a slider widget 120 with a cap at 400 according to the input limitation rule, an input text box 130, another label 140, and two buttons 150, 160, where button 160 is not clickable according to the input limitation rule. Therefore, when a human operator uses the client to remotely access the remote server, the operator may not see the text in label 110, and the operator may only modify the slider widget 120 up to a maximum of 400, and the button 160 may not be clicked.

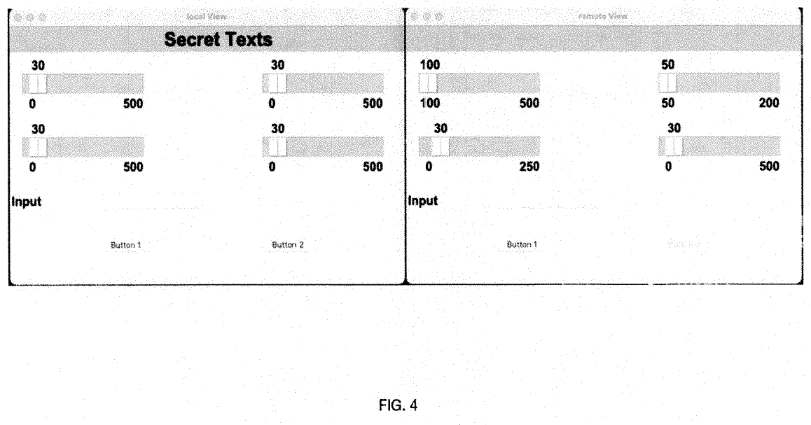

FIG. 4 demonstrates an actual reduction to practice of the systems and methods. The window shown on the left runs on the remote server, and the window shown on the right runs on the client. A preset rule in this demonstration is similar to the example in FIGS. 2 and 3, where the secret text may not be seen by the client, the client may not slide the slider over or below certain values, and one of the buttons may not be clicked by the client.

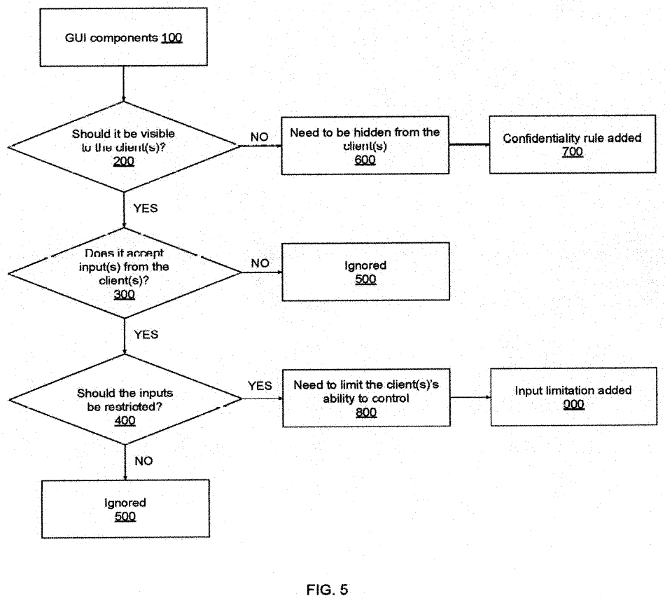

FIG. 5 is a flowchart illustrating the methods for generating a rule for a specific GUI component 100. The process begins in step 200, a human operator may decide the visibility of a GUI component 100. If a GUI component 100 shall not be visible on the client, a confidentiality rule 700 may be added to the rule database. Otherwise, if the GUI component shall be visible on the client, the GUI component may be transmitted to the client for display. One skilled in the art will recognize the various methods to render GUI components upon the client receiving the GUI component data.

In step 300, the system examines the type of the GM component 100 to determine if the component accepts any type of user inputs, such as keystrokes, clicks, mouse movements. If no input is accepted by this GUI component (such as a label, a banner, a picture), this component may be ignored 500. Ignored GUI components will not be related to any rule.

Otherwise, in step 400, For the GUI component that accepts inputs, a human operator may make a decision on the input restrictions of the GUI component. For example, a water temperature slider may range from 0 Celsius to 100 Celsius, but since the human operator decides that the client may only set the temperature up to 60 Celsius, the human operator may add a rule to limit the client's range of operation to this GUI component. Similarly, the human operator may limit the capability of the client in providing inputs to other GUI components, such as text boxes and buttons. The input limitation 900 is added to the rule database. If the human operator wants the client to have the same control privilege to the GUI component, this step may be ignored 500. Ignored GUI components will not be related to any rule.

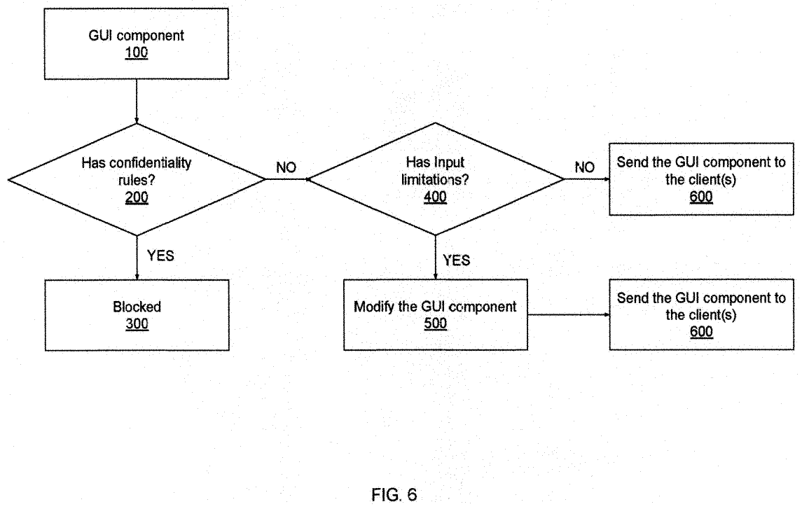

FIG. 6 is a flowchart illustrating the methods for filtering the remote server's outgoing GUI data. The GUI filter examines outgoing GUI component data 100 against the rules in the rule database. In step 200, if the GUI component is deemed to be confidential according to a preset confidentiality rule, the GUI component is blocked 300. Subsequently, the client would never receive a confidential GUI component. In step 400, if the GUI component has a limitation rule, the GUI component is modified to reflect such limitations. Such modification may visually prohibit disallowed inputs, graying out a button for example. The modified GUI component (if step 400 is YES) or unmodified GUI component (if step 400 is NO) will be sent to the client.

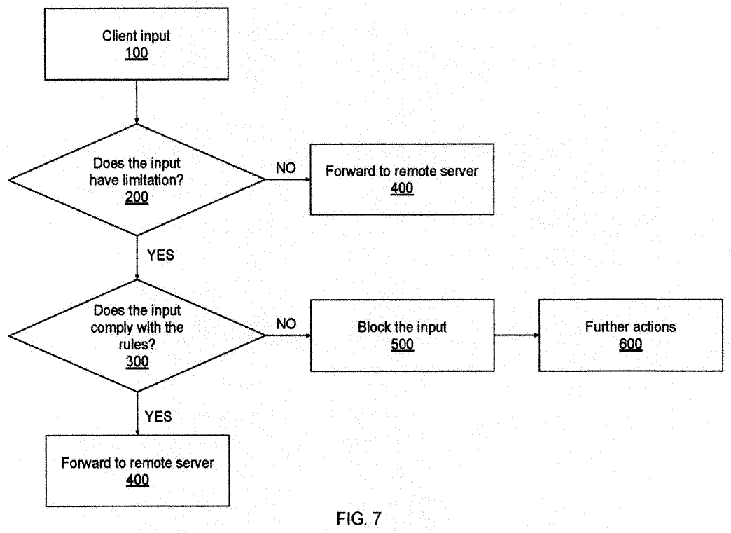

FIG. 7 is a flowchart illustrating the methods for validating the GUI inputs delivered over the network from a client to a remote server. In step 200, if the GUI component has no input limitation, the input may be forwarded to the remote server, otherwise step 300 examines whether the input complies with the preset rules associated with this GUI component. If the input violates any preset rule, for example, a rule disallows the triggering of a button, but the button is triggered by the remote client, the input will be blocked 500 and is subject to future actions 600. Inputs that are not compliant with the rules may be dropped, audited, or otherwise recorded as evidence of attempts to tamper with the remote desktop application. If the input does not violate any preset rule in step 300, the input may be forwarded to the remote server.

The invention claimed is:

1. A method of facilitating secure remote desktop session comprising:
utilizing contextual application information to determine the rules for vetting GUI components;
facilitating the construction of rules based on the confidentiality of each graphics component in an application that is to be displayed remotely on one or more clients;
facilitating the construction of rules based on the permissible range of remote control of each GUI component that acceptable user inputs in an application that is to be displayed and controlled remotely by one or more clients;
enforcing the rules through selectively forwarding GUI components, automatically modifying the GUI components based on the rules, and validating the inputs from one or more clients.

2. The method of claim 1, wherein the utilizing comprises,
determining to what degree a client is trustworthy;
determining whether to show the client a certain GUI component of the application;
determining whether to allow the client to control and/or the range of control of a certain GUI component of the application;
generating rules based on these determinations that are readable by a system conducting the GUI component filtration.

3. The method of claim 1, wherein the enforcing comprises,
a system which may allow, block, or modify outgoing GUI components from a remote server to one or more clients;
a system which may allow or block incoming GUI inputs from one or more clients to a remote server.
